(19) United States
(12) Patent Application Publication
(10) Pub. No.: US 2024/0272848 A1
(43) Pub. Date: Aug. 15, 2024

(54) RELAY SERVER, PRINTING SYSTEM, RELAY METHOD, AND PROGRAM

(71) Applicant: SEIKO EPSON CORPORATION, Tokyo (JP)

(72) Inventors: Yusuke NAKAJIMA, HINO-SHI (JP); Yu TAKEDA, HINO-SHI (JP)

(21) Appl. No.: 18/440,737

(22) Filed: Feb. 13, 2024

(30) Foreign Application Priority Data
Feb. 14, 2023 (JP) 2023-020590

(51) Int. Cl. G06F 3/12

(52) U.S. Cl. CPC G06F 3/1239; G06F 3/1203; G06F 3/1286

(57) ABSTRACT

A relay server according to an aspect of the present disclosure relays between a first print processing system and a second print processing system coupled to an image forming apparatus. The relay server includes a print data acquisition unit that acquires print data from the first print processing system, and an information acquisition unit that acquires transmitter information indicating a transmitter who transmits the print data to the first print processing system. The relay server includes a determination unit that determines, based on the transmitter information, whether a first threshold indicating an upper limit number of users of the relay server is exceeded, and an execution unit. When the determination unit determines that the first threshold is not exceeded, the execution unit executes, via the second print processing system, print processing in the image forming apparatus on the print data acquired by the print data acquisition unit.

The present application is based on, and claims priority from JP Application Serial Number 2023-020590, filed Feb. 14, 2023, the disclosure of which is hereby incorporated by reference herein in its entirety.

### BACKGROUND

### 1. Technical Field

The present disclosure relates to a relay server, a printing system, a relay method, and a program.

### 2. Related Art

JP-A-2022-038375 discloses a printing system including an information processing apparatus, a first server system, and a management server system. Here, the first server system includes a registration unit that registers first printer information in the first server system when receiving a request output from a management server system based on an instruction from a first user with first authority. The management server system includes a control unit that executes storage processing of storing first printer information and second printer information on a printing apparatus in association with each other in a storage unit of the management server system based on an instruction from a second user with second authority that is authority more restricted than the first authority. The second printer information is registered in a second server system different from the first server system and the management server system. In the management server system, a print job output from the information processing apparatus that receives the print instruction from the second user can be received by the printing apparatus via the first server system and the second server system by executing the storage processing described above.

JP-A-2022-038375 is an example of the related art.

### SUMMARY

The printing system disclosed in JP-A-2022-038375 is a system in which a plurality of server systems cooperate with one another, but there is no mechanism that restricts the number of users. Therefore, it is desired to develop a mechanism that restricts the number of users in a printing system in which a plurality of print processing systems that execute print processing cooperate with one another.

According to an aspect of the present disclosure, there is provided a relay server that relays between a first print processing system and a second print processing system coupled to an image forming apparatus, the relay server including: a print data acquisition unit configured to acquire print data from the first print processing system; an information acquisition unit configured to acquire transmitter information indicating a transmitter who transmits the print data to the first print processing system; a determination unit configured to determine, based on the transmitter information, whether a first threshold indicating an upper limit number of users of the relay server is exceeded; and an execution unit configured to execute, via the second print processing system, print processing in the image forming apparatus on the print data acquired by the print data acquisition unit, when the determination unit determines that the first threshold is not exceeded.

According to another aspect of the present disclosure, there is provided a printing system including: a relay server coupled to a first print processing system; and a second print processing system coupled to the relay server and coupled to an image forming apparatus. The relay server is a server that relays between the first print processing system and the second print processing system, and includes a print data acquisition unit configured to acquire print data from the first print processing system, an information acquisition unit configured to acquire transmitter information indicating a transmitter who transmits the print data to the first print processing system, a determination unit configured to determine, based on the transmitter information, whether a first threshold indicating an upper limit number of users of the relay server is exceeded, and an execution unit configured to execute processing of outputting, to the second print processing system, an instruction of print processing in the image forming apparatus on the print data acquired by the print data acquisition unit, when the determination unit determines that the first threshold is not exceeded. The second print processing system instructs the image forming apparatus to execute the print processing according to the instruction.

According to still another aspect of the present disclosure, there is provided a relay method for executing relay processing of relaying between a first print processing system and a second print processing system coupled to an image forming apparatus, the relay method including: acquiring print data from the first print processing system; acquiring transmitter information indicating a transmitter who transmits the print data to the first print processing system; determining, based on the transmitter information, whether a first threshold indicating an upper limit number of users provided with a service of the relay processing is exceeded; and when it is determined that the first threshold is not exceeded, executing print processing in the image forming apparatus on the acquired print data via the second print processing system.

According to still another aspect of the present disclosure, there is provided a non-transitory computer-readable storage medium storing a program for causing a computer to execute relay processing of relaying between a first print processing system and a second print processing system coupled to an image forming apparatus, in which the relay processing includes: acquiring print data from the first print processing system; acquiring transmitter information indicating a transmitter who transmits the print data to the first print processing system; determining, based on the transmitter information, whether a first threshold indicating an upper limit number of users provided with a service of the relay processing is exceeded; and when it is determined that the first threshold is not exceeded, executing print processing in the image forming apparatus on the acquired print data via the second print processing system.

### BRIEF DESCRIPTION OF THE DRAWINGS

FIG. 1 is a block diagram showing a configuration example of a printing system according to an embodiment.

FIG. 2 is a block diagram showing a configuration example of a relay server in the printing system in FIG. 1.

FIG. 3 is a sequence diagram showing an example of relay processing executed in the printing system in FIG. 1.

FIG. 4 is a sequence diagram showing another example of the relay processing executed in the printing system in FIG. 1.

FIG. 5 is a diagram showing an example of non-restricted users and priority transmitters with respect to a total number of users of a relay server at a certain time point referred to in the relay processing in FIG. 4.

FIG. 6 is a diagram showing another example of non-restricted users and priority transmitters with respect to a total number of users of the relay server at a certain time point referred to in the relay processing in FIG. 4.

FIG. 7 is a diagram showing another example of non-restricted users and priority transmitters with respect to the total number of users of the relay server at a certain time point referred to in the relay processing in FIG. 4.

FIG. 8 is a diagram showing an example of a hardware configuration of an apparatus.

### DESCRIPTION OF EMBODIMENTS

Hereinafter, an embodiment of the present disclosure will be described with reference to the drawings. Each of the drawings is merely an example showing the embodiment of the present disclosure. Not all of the components described in the embodiment of the present disclosure are essential components of the present disclosure.

### Embodiment

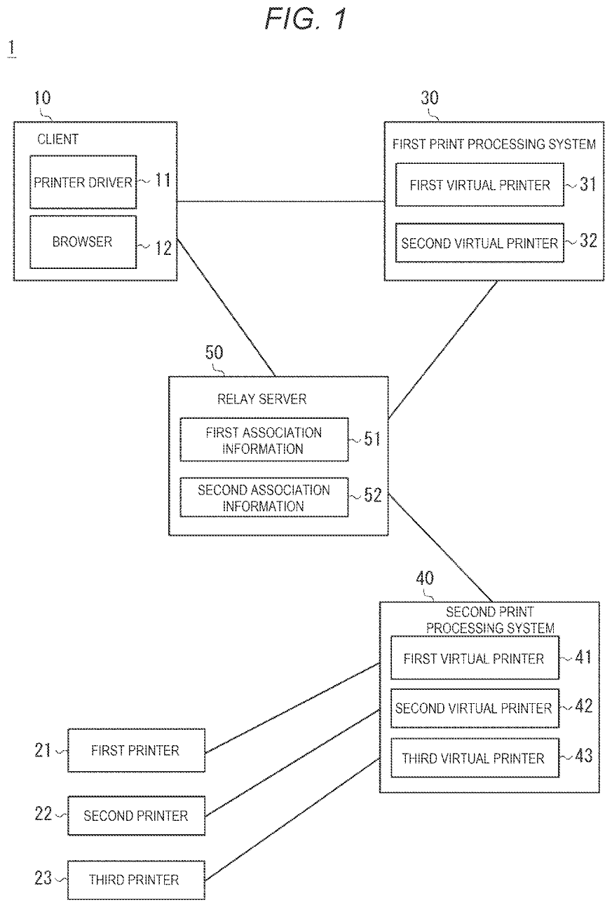

A configuration example of a printing system according to an embodiment will be described with reference to FIG. 1. FIG. 1 is a block diagram showing the configuration example of the printing system according to the embodiment.

As shown in FIG. 1, a printing system 1 according to the embodiment includes a client 10, a first printer 21, a second printer 22, a third printer 23, a first print processing system 30, a second print processing system 40, and a relay server 50.

Hereinafter, the printing system 1 shown in FIG. 1 will be described as an example of the printing system according to the embodiment, and a plurality of configurations in the printing system 1 as desired such as a portion including the relay server 50 and the second print processing system 40 may also be referred to as a printing system. In the present specification, the server may refer to a server computer, but may also be read as a server program.

The client 10 is an information processing apparatus having a communication function, such as a personal computer (PC), a smartphone, or a tablet terminal, and may be used by a user who desires printing. The client 10 may include a display unit and an operation unit (not shown) as an interface for operation. Although not shown, the printing system 1 may include a plurality of clients 10.

The client 10 is coupled to the first print processing system 30 via a network or the like for processing of transmitting a print request. The client 10 may include a printer driver 11 for selecting a printer and issuing a print request. In the embodiment, the printer to be selected is a virtual printer (to be described later) registered in the first print processing system 30 in order to manage a print job or the like.

The printer driver 11 for the selected printer can convert a print target file such as a document file that the user of the client 10 desires to print into print data that is data in a format printable by the printer. The client 10 can transmit a print request to which the print data is attached or included to the first print processing system 30. In the following description, it is assumed that the print data is attached to the print request.

The client 10 may also include a browser 12 for displaying on the display unit a user interface image for various settings in the first print processing system 30, the relay server 50, the second print processing system 40, and the like. The user of the client 10 can execute various settings through the browser 12. The settings may also include printer registration settings. For such settings, the client 10 can be coupled to the relay server 50 and the second print processing system 40 via a network.

The first printer 21, the second printer 22, and the third printer 23 are examples of an image forming apparatus, and can print on a medium when print data is received. For convenience, it is assumed that the printing system 1 includes three printers as described above, and the printing system 1 may include at least one image forming apparatus. The image forming apparatus may be an apparatus having a communication function and a print function, or may be a multifunction peripheral having other functions such as a scanner function and a copy function. The printing method used in the image forming apparatus is not limited, and various printing methods such as an ink jet printing method and a laser printing method can be applied.

Hereinafter, the first printer 21, the second printer 22, and the third printer 23 are simply referred to as printers 21, 22, and 23, respectively. The printers 21 to 23 are disposed at positions where the user of the client 10 can pick up a printed matter, but a distance between the printer and the client 10 is not limited in consideration of delivery of the printed matter.

The first print processing system 30 is a system that receives a print request and print data from the client 10 and executes print processing, and transmits the print request and print data to the relay server 50 as the print processing. In addition, the first print processing system 30 may be a system that manages print jobs and properties related to print settings for one or more printers. The print job is a print job for the received print request and print data. In the example in FIG. 1, virtual printers are registered in the first print processing system 30 so as to manage print jobs and the like of two printers among the printers 21 to 23 provided in the printing system 1.

Here, an example is described in which printers to be managed by the first print processing system 30 are a first virtual printer 31 and a second virtual printer 32, but the number of printers to be managed is not limited thereto. The printers to be managed can be registered by accessing the first print processing system 30 from the client 10 or a computer used by an administrator. The computer used by the administrator may be an information processing apparatus similar to the client 10, and may be one of the clients 10. For convenience, it is assumed in the following description that the client 10 that issues a print instruction also executes settings such as registration of the printers to be managed in advance. The first virtual printer 31 and the second virtual printer 32 are simply referred to as virtual printers 31 and 32, respectively.

Hereinafter, an example will be described in which the virtual printer 31 is a virtual printer associated with the printer 23 and the virtual printer 32 is a virtual printer associated with the printer 21.

Here, the first print processing system 30 is coupled to the printers 23 and 21 to be managed via a network or the like, thereby enabling registration of virtual printers corresponding to the printers. This coupling may be coupling via the relay server 50 and the second print processing system 40. That is, the printer as a print target of the printing system 1 can be registered in the first print processing system 30 from the client 10 via the relay server 50.

Correspondence information that associates the virtual printers 31 and 32 with the printers 23 and 21, respectively, which is the registration content, is also registered in the relay server 50 in association with similar correspondence information in the second print processing system 40 to be described later. When a registration method that does not use the relay server 50 is adopted, for relay processing, the relay server 50 may acquire the correspondence information that is the registration content from the first print processing system 30 and register the correspondence information in association with the similar correspondence information stored in the second print processing system 40 to be described later.

The first print processing system 30 may be a system that requires the user of the client 10 to be registered as a user of the first print processing system 30 such that the first print processing system 30 is available from the client 10. In this case, in the first print processing system 30, user authentication may be executed in response to access from the client 10, and a print request, print data, and registration of a virtual printer may be accepted only when the authentication is successful. The user registration may also be executed using a license-based system for each user or a license-based system specifying the number of users.

The first print processing system 30 may be implemented by a server, and may be referred to as a first print processing server. The first print processing system 30 may be implemented by a single apparatus, and may also be constructed as a distributed system in which functions are distributed among a plurality of apparatuses. It is assumed that the first print processing system 30 is constructed as a system that provides a printing service on a cloud. The first print processing system 30 may also be constructed as a system on a local network.

The second print processing system 40 is a system coupled to one or more printers that print via a network or the like, and receives a print request and print data transmitted from the client 10 and transmitted from the relay server 50 via the first print processing system 30. The second print processing system 40 then transmits the print request and the print data to the coupled printer. The second print processing system 40 may be a system that manages such print requests, that is, prints job for the coupled printer, and properties related to print settings. In the example in FIG. 1, the second print processing system 40 is a system that manages print jobs and the like of all of the printers 21 to 23 provided in the printing system 1.

Here, an example is described in which printers to be managed by the second print processing system 40 are a first virtual printer 41, a second virtual printer 42, and a third virtual printer 43, but the number of printers to be managed is not limited thereto. The printers to be managed can be registered by accessing the second print processing system 40 from the client 10 or a computer used by the administrator. For convenience, it is also assumed for the second print processing system 40 in the following description that the client 10 that issues a print instruction also executes settings such as registration of the printers to be managed in advance. The first virtual printer 41, the second virtual printer 42, and the third virtual printer 43 are simply referred to as virtual printers 41, 42, and 43, respectively.

Hereinafter, an example will be described in which the virtual printers 41, 42, and 43 are virtual printers associated with the printers 21, 22, and 23, respectively. Here, the second print processing system 40 is coupled to the printers 21 to 23 to be managed via a network or the like, and enables registration of virtual printers corresponding to the printers. The printer as a print target of the printing system 1 can be registered in the second print processing system 40 from the client 10 via the relay server 50.

Correspondence information that associates the virtual printers 41, 42, and 43 with the printers 21, 22, and 23, which is the registration content, is also registered in the relay server 50 in association with similar correspondence information in the first print processing system 30. When a registration method that does not use the relay server 50 is adopted, for relay processing, the relay server 50 may acquire the correspondence information that is the registration content from the second print processing system 40 and register the correspondence information in association with the similar correspondence information stored in the first print processing system 30.

The second print processing system 40 may be a system that requires the user of the client 10 to be registered as a user of the second print processing system 40 such that the second print processing system 40 is available directly from the client 10 without using the relay server 50. In this case, in the second print processing system 40, user authentication may be executed in response to access from the client 10, and registration of a virtual printer or the like may be accepted only when the authentication is successful. The user registration may also be executed using a license-based system for each user or a license-based system specifying the number of users.

The second print processing system 40 may be implemented by a server, and may be referred to as a second print processing server. The second print processing system 40 may be implemented by a single apparatus, and may also be constructed as a distributed system in which functions are distributed among a plurality of apparatuses.

It is assumed that the second print processing system 40 is constructed as a system that provides a printing service on a cloud. In particular, the second print processing system 40 may be constructed as a system capable of transmitting a print request and print data using an e-mail. In this case, the second print processing system 40 has an advantage of being able to transmit the print request and the print data to the printers 21 to 23 via a virtual private network (VPN). The second print processing system 40 may also be constructed as a system on a local network.

The relay server 50 is a server that relays between the first print processing system 30 and the second print processing system 40, and has a communication function to couple to the first print processing system 30 and the second print processing system 40 via a network or the like.

In order to execute print processing based on a print request and print data transmitted from the client 10 to the first print processing system 30, the relay server 50 executes relay processing of relaying the print request and print data to the second print processing system 40.

In order to execute the relay processing, the relay server 50 associates the printers 21 to 23 with the virtual printers 41 to 43 and the virtual printers 31 and 32. In the example in FIG. 1, first association information 51 and second association information 52 are registered in the relay server 50 as correspondence information for the association. For this registration, the relay server 50 can acquire information related to a printer that is registered as a virtual printer or a registerable printer, via the first print processing system 30 and the second print processing system 40.

The relay server 50 acquires a print request and print data from the first print processing system 30. This acquisition may also be executed in response to a notification indicating that the print request and the print data are acquired from the first print processing system 30. The relay server 50 refers to the first association information 51 and the second association information 52, and transmits the print request designating a virtual printer of the second print processing system 40 that is a target of the print request, and the received print data. Prior to this transmission, the relay server 50 may acquire information on the printer indicated in the notification or the acquired print request, determine whether the printer is a validated device, and transmit the print data or the like only when the printer is validated.

The first association information 51 is information that associates the virtual printer 31 and the virtual printer 43 as virtual printers of the printer 23 based on the registration content of the first print processing system 30 and the registration content of the second print processing system 40. When the first association information 51 is information that associates the virtual printer 31 and the virtual printer 43, the printer 23 can print by the relay processing. In the first print processing system 30, by registering the virtual printer 43 registered in the second print processing system 40 as the virtual printer 31, similar registration of the first association information 51 and relay processing can also be executed.

The second association information 52 is information that associates the virtual printer 32 and the virtual printer 41 as virtual printers of the printer 21 based on the registration content of the first print processing system 30 and the registration content of the second print processing system 40. When the second association information 52 is information that associates the virtual printer 32 and the virtual printer 41, the printer 21 can print via the second print processing system 40 by the relay processing. In the first print processing system 30, by registering the virtual printer 41 registered in the second print processing system 40 as the virtual printer 32, similar registration of the second association information 52 and relay processing can also be executed.

The relay server 50 may be implemented by a single apparatus, and may also be constructed as a distributed system in which functions are distributed among a plurality of apparatuses. It is assumed that the relay server 50 is constructed as a cloud system, and the relay server 50 may also be constructed as a system on a local network.

In the printing system 1 configured as described above, the print request and the print data from the client 10 are received by the first print processing system 30 and passed to the second print processing system 40 through the relay processing by the relay server 50, and finally the printer prints.

In the printing system 1 according to the embodiment, processing of restricting the number of users of the relay service to a predetermined upper limit value is executed, and the relay server 50 executes the processing. That is, the relay server 50 executes the relay processing such that printing is used within a range of a predetermined upper limit value of the number of people. Printing from the client 10 may be restricted in the relay processing.

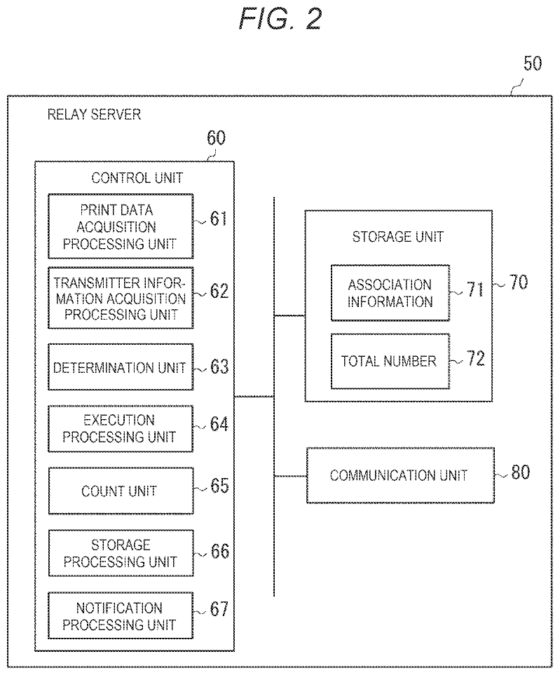

Next, with reference to FIG. 2, an example of the relay processing with such a restriction will be described, and a configuration example of the relay server 50 that executes the relay processing will be described. FIG. 2 is a block diagram showing the configuration example of the relay server 50 in the printing system 1 in FIG. 1.

As shown in FIG. 2, the relay server 50 may include a control unit 60, a storage unit 70, and a communication unit 80. The control unit 60 may include a print data acquisition processing unit 61, a transmitter information acquisition processing unit 62, a determination unit 63, and an execution processing unit 64. The control unit 60 may further include a count unit 65 and a storage processing unit 66. The control unit 60 may further include a notification processing unit 67.

The control unit 60 may include, for example, an arithmetic processing apparatus such as a central processing unit (CPU) or a graphics processing unit (GPU), a working memory, and a storage apparatus that stores a control program, parameters, and the like. The control unit 60 may also be implemented as a system on a chip (SoC). As can be seen from these examples, the control unit 60 may store a control program in an executable state. The control unit 60 may store the control program as a circuit configuration such as a field-programmable gate array (FPGA), or may be implemented as a dedicated circuit. The print data acquisition processing unit 61, the transmitter information acquisition processing unit 62, the determination unit 63, the execution processing unit 64, the count unit 65, the storage processing unit 66, and the notification processing unit 67 can be implemented as the above programs. The above programs may include a program for the arithmetic processing apparatus to implement functions of the units 61 to 67 in cooperation with the storage unit 70 and the communication unit 80.

The storage unit 70 is, for example, a storage apparatus including a hard disk drive, a solid state drive, or another memory. A part of the memory provided in the control unit 60 may be regarded as the storage unit 70. That is, the storage unit 70 may also be regarded as a part of the control unit 60.

Association information 71 exemplified by the first association information 51 and the second association information 52 is stored in the storage unit 70, and referred to when executing the relay processing, whereby the print data can be transmitted to any one of the printers 21 to 23 desired by the client 10 to be printed. The association information 71 can be stored as a table. The storage unit 70 may also store a total number 72 to be described later.

The communication unit 80 may be one or more communication interfaces for communicating with one or more external apparatuses through wired connection or wireless connection in accordance with a predetermined communication protocol including a predetermined communication standard. The printing system 1 includes at least the first print processing system 30 and the second print processing system 40 as the external apparatuses. As described above, the printing system 1 can be configured such that the communication unit 80 also communicates with the client 10 as an external apparatus.

The print data acquisition processing unit 61 acquires print data from the first print processing system 30 via the communication unit 80. This acquisition can be executed in response to a notification indicating that a print request is received from the first print processing system 30, and can also be executed by spontaneously transmitting the print data together with the print request from the first print processing system 30. In this way, the acquired print data is transmitted from the client 10 to the first print processing system 30 together with the print request, and is transferred from the first print processing system 30. The print data acquisition processing unit 61 can temporarily store the acquired print data in the storage unit 70. The print data acquisition processing unit 61 and the communication unit 80 are an example of a print data acquisition unit that acquires the print data from the first print processing system 30.

The transmitter information acquisition processing unit 62 acquires transmitter information via the communication unit 80. Here, the transmitter information is information indicating a transmitter who transmits the print data to the first print processing system 30. The transmitter information acquisition processing unit 62 may acquire the transmitter information from the first print processing system 30, and description will be made on the assumption of such an acquisition path, and the transmitter information acquisition processing unit 62 may also acquire the transmitter information via another system (not shown). For such acquisition, the first print processing system 30 may manage the transmitter information.

A timing of acquiring the transmitter information may be the same as that of the print data acquired from the first print processing system 30, or may be after or before the print data is acquired as long as it can be determined that the transmitter information is for the print data. This acquisition can be executed by receiving a notification indicating that a print request is received from the first print processing system 30, and can also be executed by the first print processing system 30 spontaneously transmitting the transmitter information together with the print request or included in the print request.

The transmitter information acquisition processing unit 62 can temporarily store the acquired transmitter information in the storage unit 70. The transmitter information acquisition processing unit 62 and the communication unit 80 are an example of an information acquisition unit that acquires the above transmitter information.

Based on the transmitter information acquired by the transmitter information acquisition processing unit 62, the determination unit 63 determines whether a first threshold indicating an upper limit number of users of the relay server 50 is exceeded. For example, the determination unit 63 may determine that the first threshold is exceeded when a transmitter indicated by the transmitter information acquired this time is a user of the relay server 50. This determination is executed as to whether to restrict printing regarding the print data acquired by the print data acquisition processing unit 61.

Hereinafter, the user of the relay server 50, that is, a user who can enjoy the relay service of the relay server 50 is referred to as a relay user, and user information of the relay server 50 is referred to as relay user information. The determination by the determination unit 63 can be executed with reference to all the transmitter information acquired at this time point, including the transmitter information acquired this time. The transmitter information, or information on the transmitter included in the transmitter information, for example, the relay user information indicating the transmitter who is not restricted from printing, can be stored in the storage unit 70 for reference.

When the determination unit 63 determines that the first threshold is not exceeded, the execution processing unit 64 executes, via the second print processing system 40, print processing on the printer for the print data acquired by the print data acquisition processing unit 61. That is, when the determination unit 63 determines that the first threshold is not exceeded, the execution processing unit 64 permits print processing on the printer for the print data acquired by the print data acquisition processing unit 61, and executes the print processing using the second print processing system 40.

Execution and non-execution of the print processing according to such a first threshold corresponds to a restriction on the relay users made in the above relay processing. Such a restriction for printing according to the first threshold can be made by counting the number of relay users, and such an example will be described later in the description of the count unit 65 and the like.

The execution processing unit 64 can execute the print processing by outputting an instruction for the print processing to the second print processing system 40 via the communication unit 80. The second print processing system 40 instructs the printer to execute the print processing according to this instruction, and the printer that receives the instruction executes the print processing.

The execution processing unit 64 and the communication unit 80 are an example of an execution unit. The execution unit executes, when the determination unit 63 determines that the first threshold is not exceeded, via the second print processing system 40, the print processing by the printer for the print data acquired by the print data acquisition processing unit 61.

The relay server 50 configured as described above can limit the number of relay users in the printing system in which two print processing systems that execute the print processing cooperate.

In this way, the relay processing executed by the relay server 50 includes acquiring print data from the first print processing system 30 and acquiring transmitter information indicating a transmitter who transmits the print data to the first print processing system 30. The relay processing further includes determining, based on the transmitter information, whether a first threshold indicating an upper limit number of users provided with a service of the relay processing is exceeded. The relay processing further includes processing of executing print processing by the printer for the acquired print data via the second print processing system 40 when it is determined that the first threshold is not exceeded.

Next, the count unit 65, the storage processing unit 66, and the notification processing unit 67 that may be provided in the relay server 50 will be described.

When the determination unit 63 determines that the first threshold is not exceeded, the count unit 65 counts the transmitter indicated by the transmitter information as a relay user. Here, since the count unit 65 executes a count as the relay user, it means that the transmitter is not counted twice even when the first threshold is not exceeded.

More specifically, when the determination unit 63 determines that the first threshold is not exceeded and the transmitter indicated by the transmitter information is not counted as the relay user, the count unit 65 can count the transmitter as the relay user. Alternatively, the determination unit 63 may first determine whether a current transmitter is an already registered relay user, and executes determination using the first threshold only when the current transmitter is not an already registered relay user. In this case, when the determination unit 63 determines that the first threshold is not exceeded, the count unit 65 may count the transmitter indicated by the transmitter information as the relay user.

The storage processing unit 66 executes processing of storing the total number 72 of relay users in the storage unit 70 according to the count by the count unit 65. The storage processing unit 66 and the storage unit 70 are an example of a total number storage unit that stores the total number 72, that is, a total count number.

The total number 72 can be set to an upper limit value for the relay users in the relay server 50, and the relay server 50 restricts the number of relay users to the upper limit value. Therefore, a company that provides the relay server 50 can provide a license-based relay service in which the number of relay users is defined by an upper limit value to, for example, a company where the client 10 is installed.

As registration processing of the transmitter information, the storage processing unit 66 can execute processing of registering the transmitter information as relay user information in the storage unit 70 when the transmitter indicated by the transmitter information is counted as the relay user. Of course, at the time of registration, it is not necessary to register the content included in the transmitter information itself as the relay user information, as long as the relay user information includes information indicating the transmitter.

When the transmitter of the print data acquired by the print data acquisition processing unit 61 is the relay user, the execution processing unit 64 permits the print processing for the print data and executes the print processing via the communication unit 80. In other words, the execution processing unit 64 may permit the print processing in both a case where the transmitter is counted as the relay user, that is, a case where the total number 72 is updated and a case where the transmitter is already counted as the relay user. In this way, when the transmitter of the print data is a counted transmitter that is included in the total number 72, the execution processing unit 64 can permit the print processing even though the count is not a count added at a current time point but a past count.

On the other hand, when the determination unit 63 determines that the first threshold is exceeded, the count unit 65 does not count the transmitter indicated by the transmitter information as the relay user, and the execution processing unit 64 restricts, that is, does not permit a print request of the transmitter.

When the determination unit 63 determines that the first threshold is exceeded, in addition to such a restriction, the notification processing unit 67 may execute processing of notifying the first print processing system 30 via the communication unit 80. A notification content may be any content indicating that printing cannot be performed due to the restriction. The notification processing unit 67 and the communication unit 80 can constitute a notification unit that executes such a notification. The first print processing system 30 that receives such a notification transmits a notification of the same content to the client 10, whereby the user of the client 10 can know that printing cannot be performed due to the restriction.

The print processing in the execution processing unit 64 can be executed with reference to the association information 71 stored in the storage unit 70. Therefore, as registration processing of the association information, the storage processing unit 66 can also execute processing of storing, in the storage unit 70, the association information 71 as exemplified in the first association information 51 and the second association information 52. The association information 71 may be stored, that is, registered for each user of the client 10 as the transmitter here, and may be registered as common information regardless of the user of the client 10 as the transmitter.

In this way, the storage processing unit 66 and the storage unit 70 can store the association information 71, and are an example of a registration unit that registers a correspondence relationship between the first print processing system 30 and the second print processing system 40.

The relay server 50 may accept an operation to change the association information 71 from the client 10, and in this case, the relay server 50 may accept the change only when the user of the client 10 is the relay user. Alternatively, only changes such as replacement or new registration of the virtual printers 41 to 43 on the second print processing system 40 side in the association information 71 may be accepted.

The relay server 50 may store information indicating the administrator in the storage unit 70, determine whether the user is the administrator when an operation to change the association information 71 is received from the client 10, and accept the change operation only when the user is the administrator.

With a configuration described above, the printing system 1 can execute the print processing in a system in which the first print processing system 30 and the second print processing system 40 cooperate when the upper limit value of the number of people who can use the relay server 50 is not exceeded. As described above, in order to determine whether this upper limit value is exceeded, the relay server 50 may count the number of relay users executing the print processing when the relay server 50 acquires the print data from the first print processing system 30 and determines that the transmitter is a transmitter who can execute printing.

In the printing system 1, it is assumed that the relay user is registered at the time of the print request for convenience, and for example, the relay user can also be registered by the administrator or the like by issuing a registration request instead of the print request.

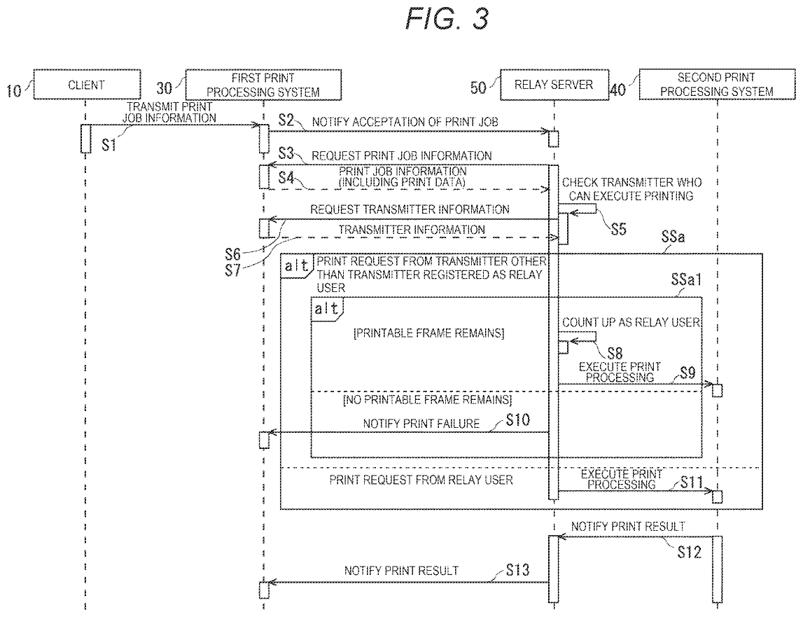

Next, an example of the above relay processing will be described with reference to FIG. 3. FIG. 3 is a sequence diagram showing the example of the relay processing executed in the printing system 1. In FIG. 3, the user of the client 10 and the printers 21 to 23 coupled to the second print processing system 40 are not shown.

First, the user of the client 10 performs a print operation, and the client 10 that receives the print operation transmits print job information including print data as a print request to the first print processing system 30 (step S1). At this time, the client 10 can also transmit transmitter information to the first print processing system 30 together with the print job information. In the following description, the print job information and the transmitter information are described as separate information, but the transmitter information may be included in the print job information. The first print processing system 30 that receives the print job information notifies the relay server 50 that the print job is accepted (step S2).

The relay server 50 requests the print job information from the first print processing system 30 in response to this notification (step S3), and receives and acquires the print job information including the print data from the first print processing system 30 (step S4).

The relay server 50 checks whether a transmitter who transmits the print request for the acquired print job information is a transmitter who can execute printing (step S5). In this checking, the relay server 50 requests the transmitter information from the first print processing system 30 (step S6), and receives and acquires the transmitter information (step S7). The acquired transmitter information may include not only information indicating the transmitter but also information indicating a belonging group to which the transmitter belongs.

The checking processing in step S5 can be executed by determining whether the transmitter indicated by the acquired transmitter information is a relay user, and whether a first threshold is exceeded by accepting the print request when the transmitter is a transmitter other than the relay user. The transmitter information acquired in step S4 is used to determine whether the transmitter has a qualification to print in the checking processing in step S5, and thus may be referred to as qualification information.

As shown in the drawing, as branch processing SSa, the relay server 50 executes branch processing SSal when the print request is from a transmitter other than the transmitter registered as the relay user. In the branch processing SSal, the relay server 50 determines whether a printable frame remains with respect to the upper limit number. When a result of this determination indicates that the printable frame remains, the relay server 50 counts up the transmitter as the relay user (step S8), and requests the second print processing system 40 to execute the print processing (step S9). On the other hand, when the result of this determination indicates that no printable frame remains, the relay server 50 does not count up the transmitter as the relay user, and notifies the first print processing system 30 that printing fails (step S10).

On the other hand, when the print request is from the transmitter registered as the relay user, the relay server 50 requests the second print processing system 40 to execute the print processing (step S11).

The request to execute the print processing in steps S9 and S11 can be made as follows, for example. Based on the association information 71, the relay server 50 generates a print request to a virtual printer of the second print processing system 40 associated with a virtual printer of the first print processing system 30 designated by the transmitter, and transmits the print request to the second print processing system 40. The print request includes the print data received in step S7. For any of the requests in steps S9 and S11, the second print processing system 40 instructs a printer associated with the virtual printer indicated by the received print request to print.

According to this processing, for example, when the client 10 designates the virtual printer 31 and issues a print request, the relay server 50 converts the print request into a print request to the virtual printer 43 based on the first association information 51. Then, the second print processing system 40 instructs the printer 23 to print, and the printer 23 prints. At this time, the second print processing system 40 may notify the printer 23 that there is print job information, and the printer 23 may acquire the print job information and print data included in the print job information.

Similarly, when the client 10 designates the virtual printer 32 and issues a print request, the relay server 50 converts the print request into a print request to the virtual printer 41 based on the second association information 52. Then, the second print processing system 40 instructs the printer 21 to print, and the printer 21 prints. At this time, the second print processing system 40 may notify the printer 21 that there is print job information, and the printer 21 may acquire the print job information and print data included in the print job information.

After the processing in step S11, the second print processing system 40 notifies the relay server 50 of a print result indicating whether printing by the printer is normally completed or an error occurs in the printer (step S12). The relay server 50 that receives the print result notifies the first print processing system 30 of the print result (step S13). Although not shown, the first print processing system 30 that receives the print result can notify the client 10 that issues the print request of the print result.

As described above, the relay server 50 identifies the transmitter who transmits the print request based on the determination, and counts up based on the upper limit number of relay users who can execute printing, thereby permitting printing on a first-come, first-served basis in which the print request is transmitted. The relay server 50 can also register the relay users who can execute printing. The count unit 65 counts at a time point when the relay server 50 transmits the print data to the second print processing system 40, that is, a time point when printing is deemed to be permitted. Accordingly, the relay server 50 can accurately identify the transmitter who can execute printing for the subsequent print request based on this count.

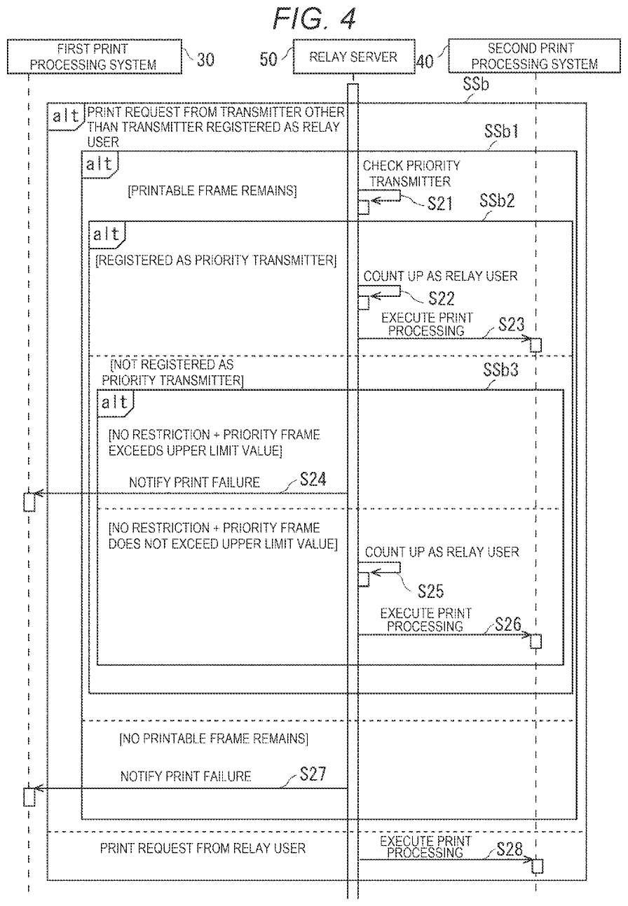

Next, another example of the relay processing will be described with reference to FIG. 4. FIG. 4 is a sequence diagram showing the other example of the relay processing executed in the printing system 1. In a sequence shown in FIG. 4, an example of branch processing that can be executed instead of the branch processing SSa in a sequence shown in FIG. 3 is shown as branch processing SSb, and the other processing is as described with reference to FIG. 3.

As shown in the drawing, as the branch processing SSb, the relay server 50 executes branch processing SSb1 when a print request is from a transmitter other than the transmitter registered as the relay user. In the branch processing SSb1, the relay server 50 determines whether a printable frame remains with respect to the upper limit number.

When a result of this determination indicates that the printable frame remains with respect to the upper limit number, the relay server 50 checks priority transmitters based on target transmitter information (step S21). In step S21, it is determined whether the transmitter indicated by the transmitter information is a priority transmitter, and this determination may also be executed by the determination unit 63.

Here, the priority transmitter is a transmitter who can execute printing with priority. This determination can be executed by storing information indicating the priority transmitter in the storage unit 70 in advance. Alternatively, the transmitter information acquisition processing unit 62 may acquire information indicating whether the transmitter is the priority transmitter from the first print processing system 30 via the communication unit 80.

The transmitter information received from the first print processing system 30 may include attribute information such as a group to which the transmitter belongs and a position of the transmitter, and information indicating the priority transmitter may be registered in the storage unit 70 as information indicating an attribute for printing with priority. In this way, priority transmitters can be registered individually as priority members or as a priority group for the transmitters. The priority transmitters may be registered by in both ways, that is, some transmitters may be registered as priority members and other transmitters may be registered as belonging to a priority group.

When it is indicated that the transmitter is registered as the priority transmitter, the relay server 50 counts up the transmitter as the relay user (step S22), and requests the second print processing system 40 to execute the print processing (step S23).

In step S22, the relay server 50 also counts up the transmitter as the priority user. This counting up can also be executed by the count unit 65. The priority user refers to a user registered as a priority transmitter who can execute printing with priority among the relay users. The counting up of priority users is also executed to restrict the total number of priority users. Here, the total number of priority users is restricted so as not to exceed a third threshold that is equal to or less than the upper limit number as the first threshold and that indicates an upper limit number of priority users who can execute printing with priority among the relay users. Therefore, a transmitter whose number exceeds the third threshold, even a priority transmitter, will not be registered as priority users.

On the other hand, when it is indicated that the transmitter is not registered as the priority transmitter, the relay server 50 executes branch processing SSb3. In the relay server 50, a transmitter who is permitted to execute printing without any restriction among the transmitters can be registered as a non-restricted user, and an example will be described in which a concept of such a non-restricted user is also adopted in the branch process SSb3. The non-restricted user corresponds to a relay user having no restriction, and is a user registered as a relay user who can execute printing from a time point when a print request is not issued.

In the branch processing SSb3, the relay server 50 determines whether a sum of the number of non-restricted users and the number of priority frames ensured for the priority users exceeds the upper limit value of the first threshold. This determination can also be executed by the determination unit 63.

When a result of this determination indicates that the upper limit value of the first threshold is exceeded, the relay server 50 notifies the first print processing system 30 that printing fails since even a priority transmitter cannot be registered as a priority user any more (step S24).

On the other hand, when the result of this determination indicates that the upper limit value of the first threshold is not exceeded, the relay server 50 counts up the transmitter as the relay user (step S25), and requests the second print processing system 40 to execute the print processing (step S26). In step S25, the relay server 50 also counts up the transmitter as the priority user as in step S22.

In the branch processing SSb1, the relay server 50 notifies the first print processing system 30 that printing fails (step S27) when no printable frame remains with respect to the upper limit number as the first threshold.

In the branch processing SSb, the relay server 50 requests the second print processing system 40 to execute the print processing when the print request is from the transmitter registered as the relay user (step S28). The request to execute the print processing in steps S23, S26, and S28 and the subsequent printing are as described in steps S9 and S11.

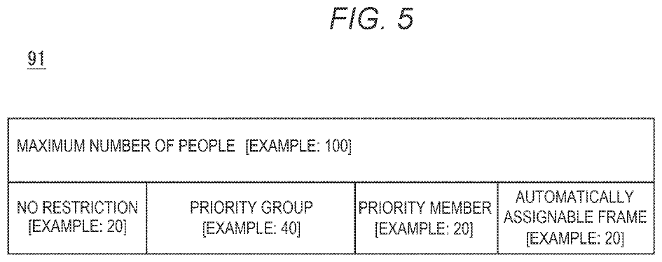

In a processing example shown in FIG. 4, a situation in which printing is restricted will be described with reference to FIGS. 5 to 7 using specific examples. FIGS. 5 to 7 are diagrams each showing an example of non-restricted users and priority transmitters with respect to the total number of relay users at a certain time point referred to in the relay processing in FIG. 4, and FIGS. 5 to 7 show examples different to one another.

An example 91 shown in FIG. 5 is an example when the upper limit number as the first threshold, that is, the maximum number of people is 100, and the number ensured as the priority frames does not exceed the maximum number of people. In the example 91, 20 non-restricted users who are relay users having no registration are registered, 40 people are ensured as registerable frames of the priority group, 20 people are ensured as registrable frames of the priority members, and automatically assignable frames are reserved for 20 people. A print request from a transmitter who is not the non-restricted user or the priority member, nor belongs to the priority group is assigned on a first-come, first-served basis within a range of the automatically assignable frames.

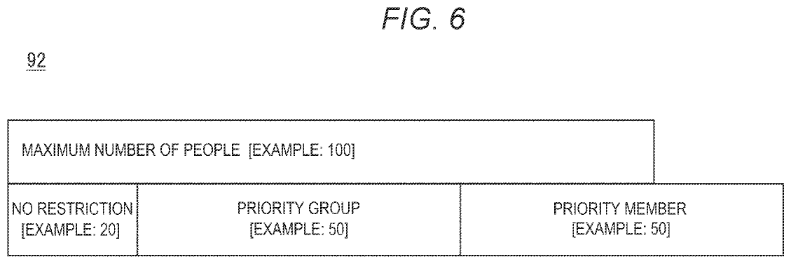

An example 92 shown in FIG. 6 is an example when the maximum number of people is 100 and the number ensured as the priority frames exceeds the maximum number of people. In the example 92, 20 non-restricted users are registered, 50 people are ensured as registerable frames of the priority group, and 50 people are ensured as registerable frames of the priority members, and there is no automatically assignable frames. Priority transmitters corresponding to the priority members and the priority group can execute printing on a first-come, first-served basis until 80 people obtained by subtracting the number of non-restricted users from the maximum number of 100 people is exceeded, but even the priority transmitter cannot print if 80 people is exceeded. For print requests from transmitters who are not the non-restricted users or the priority transmitters, printing will not always be performed.

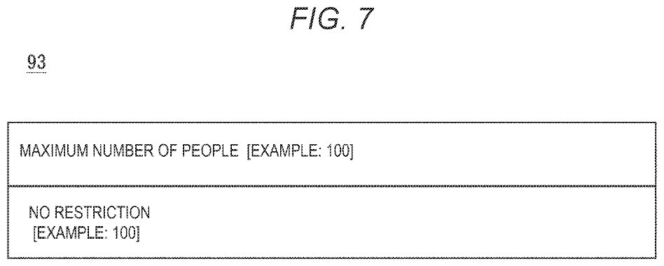

An example 93 shown in FIG. 7 is an example when the maximum number of people is 100 and all the 100 people are registered as non-restricted users. In the example 93, the non-restricted users can always use printing, but the priority transmitters cannot use printing, and the transmitters who are not the non-restricted users or the priority transmitters cannot use printing either.

As exemplified in the branch processing SSb1, the determination unit 63 can determine whether the transmitter indicated by the transmitter information is a priority transmitter, and can determine whether the third threshold is exceeded when the transmitter indicated by the transmitter information is the priority transmitter.

In such a determination, as exemplified in the branch processing SSb2, when the determination unit 63 determines that the third threshold is not exceeded, the count unit 65 may count the priority transmitter indicated by the transmitter information as a priority user. Then, the storage processing unit 66 may execute processing of storing, as a type of the total number 72, a total number of priority users in the storage unit 70 according to the count by the count unit 65. As exemplified in steps S23 and S28, when the transmitter of the print data acquired by the print data acquisition processing unit 61 is the priority user, the execution processing unit 64 permits the print processing for the print data and executes the print processing via the communication unit 80.

In the branch processing SSb3, an example in which non-restricted users are also taken into account is shown, but processing in which non-restricted users are not taken into account is also possible. That is, when the transmitter indicated by the transmitter information is not the priority transmitter, the determination unit 63 may execute processing of determining whether a fourth threshold obtained by subtracting the third threshold from the first threshold is exceeded. Then, when the determination unit 63 determines that the fourth threshold is not exceeded, the count unit 65 counts the transmitter indicated by the transmitter information as a relay user, and the storage processing unit 66 stores a total number of relay users according to the count by the count unit 65. According to this example, when the fourth threshold obtained by subtracting an upper limit number of priority users from a total upper limit number is not exceeded, that is, when a frame that is automatically registerable on a first-come, first-served basis remains, the transmitter can be automatically assigned as a relay user.

As exemplified in steps S24 and S27, the notification processing unit 67 may transmit a notification indicating a failure to the first print processing system 30 when it is determined that a threshold is exceeded even for determination using a threshold other than the first threshold.

In the determination for branching in steps S24 and S25, it is determined whether a sum of the number of non-restricted users and the number of people ensured for the priority users exceeds the upper limit value of the first threshold. Instead of the first threshold, the determination unit 63 may determine whether the second threshold obtained by subtracting the number of non-restricted users who are not restricted from printing among the relay users from the upper limit number is exceeded. In such a determination, when the transmitter indicated by the transmitter information is a non-restricted user who is not restricted from printing, the count unit 65 does not count the transmitter as the relay user.

Of course, an example in which the determination using the second threshold instead of the first threshold and the count for the non-restricted user are not executed can also be applied to the example in FIG. 3.

As described above, in addition to the processing example in FIG. 3, the relay server 50 in the processing example in FIG. 4 can register a non-restricted user who is not restricted from printing, register a priority member and a priority group who can execute printing with priority, and restrict the number of relay users based on the registration. In particular, the processing example in FIG. 4 has an effect that the transmitter who transmits the print request can be prioritized as the relay user who can execute printing. The relay server 50 first compares the transmitter with the non-restricted user, and if applicable, does not newly count the transmitter, and then compares the transmitter with the priority member and the priority group, and an order of these comparisons does not matter.

Not limited to the example in FIG. 3 and the example in FIG. 4, the relay server 50 can automatically delete the registered relay user periodically. Here, the periodic deletion may be executed at a timing at which a specific period such as a specific number of days or a specific time has elapsed, or at a predetermined timing such as the beginning of a month. The relay server 50 may also be able to accept and reflect designation or change of the periodic deletion timing by the administrator or the like.

### Other Modifications

The present disclosure is not limited to the above embodiment, and can be appropriately modified without departing from the scope of the present disclosure. For example, an example is shown in which the relay server 50 and the second print processing system 40 have different configurations, and the relay server 50 may include the second print processing system 40, that is, the relay server 50 and the second print processing system 40 may be constructed as an integrated system. In this case, a function described as a function of the relay server 50 may pass a print processing instruction to a function described as the second print processing system 40.

Although the relay server according to the embodiment relays between two print processing systems, the printing system may include three or more print processing systems and one or more relay servers for relaying among the print processing systems.

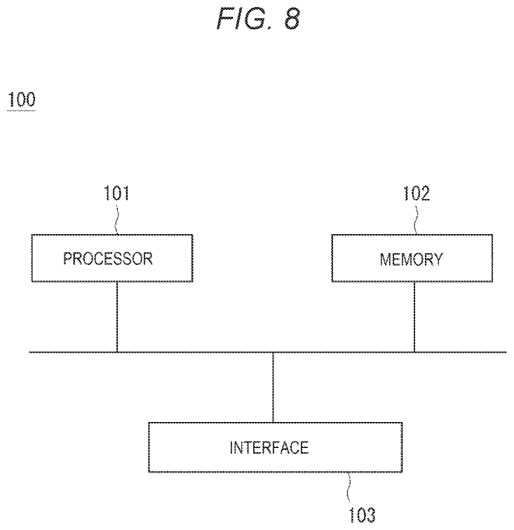

The apparatuses provided in the printing system according to the above embodiment may have, for example, the following hardware configuration. Here, in the example in FIG. 1, the apparatuses include a client, a first print processing system, a second print processing system, and a relay server. Of course, for example, each of the first print processing system, the second print processing system, and the relay server may be constructed as a distributed system in which a plurality of apparatuses are distributed, and in this case, each of the apparatuses may indicate the plurality of apparatuses. FIG. 8 is a diagram showing an example of a hardware configuration of an apparatus.

An apparatus 100 shown in FIG. 8 may include a processor 101, a memory 102, and an interface 103. The interface 103 may include, for example, a communication interface or an interface with an input and output apparatus, which are necessary depending on the apparatus.

The processor 101 may be, for example, a CPU, a GPU, or a microprocessor unit (MPU) also referred to as a microprocessor. The processor 101 may include a plurality of processors. The memory 102 is, for example, a combination of a volatile memory and a nonvolatile memory. Functions of the apparatuses are implemented by the processor 101 reading a program stored in the memory 102 and executing the program while exchanging necessary information via the interface 103. For example, when the apparatus 100 is a relay server, the program may include a program for causing the processor 101 to execute the relay processing as described above.

The program described above includes an instruction group (or a software code) for causing a computer to implement one or more functions described in the embodiment when loaded into the computer. The program may be stored in a non-transitory computer-readable medium or a tangible storage medium. Examples of the computer-readable medium or the tangible storage medium include, but are not limited to, a random-access memory (RAM), a read-only memory (ROM) , a flash memory, a solid-state drive (SSD), and other memory techniques. Examples of the computer-readable medium or the tangible storage medium include, but are not limited to, a CD-ROM, a digital versatile disc (DVD), a Blu-ray (registered trademark) disk, another optical disk storage, a magnetic cassette, a magnetic tape, a magnetic disk storage, or another magnetic storage device. The program may be transmitted on a temporary computer-readable medium or a communication medium. Examples of the transitory computer-readable medium or the communication medium include, but are not limited to, electrical, optical, acoustic, or other forms of propagating signals.

Although the present disclosure has been described with reference to the above embodiment, the present disclosure is not limited only to the configuration of the above embodiment, and it goes without saying that the present disclosure includes various variations, modifications, and combinations that can be made by those skilled in the art within the scope of the disclosure in the claims of the present application.

What is claimed is:

1. A relay server that relays between a first print processing system and a second print processing system coupled to an image forming apparatus, the relay server comprising:
a print data acquisition unit configured to acquire print data from the first print processing system;
an information acquisition unit configured to acquire transmitter information indicating a transmitter who transmits the print data to the first print processing system;
a determination unit configured to determine, based on the transmitter information, whether a first threshold indicating an upper limit number of users of the relay server is exceeded; and
an execution unit configured to execute, via the second print processing system, print processing in the image forming apparatus on the print data acquired by the print data acquisition unit, when the determination unit determines that the first threshold is not exceeded.

2. The relay server according to claim 1, wherein
the information acquisition unit acquires the transmitter information from the first print processing system.

3. The relay server according to claim 1, further comprising:
a count unit configured to count the transmitter indicated by the transmitter information as the user when the determination unit determines that the first threshold is not exceeded; and
a total number storage unit configured to store a total number of the users according to a count by the count unit, wherein
the execution unit executes print processing on the print data acquired by the print data acquisition unit when the transmitter of the print data is the user.

4. The relay server according to claim 3, wherein
the count unit counts the transmitter indicated by the transmitter information as the user when the determination unit determines that the first threshold is not exceeded and the transmitter indicated by the transmitter information is not yet counted as the user.

5. The relay server according to claim 3, wherein
the determination unit determines whether a second threshold is exceeded instead of the first threshold, the second threshold being obtained by subtracting, from the upper limit number, the number of non-restricted users who are not restricted from printing among the users, and
when the transmitter indicated by the transmitter information is a non-restricted user who is not restricted from printing, the count unit does not count the transmitter as the user.

6. The relay server according to claim 1, wherein
when the transmitter indicated by the transmitter information is a priority transmitter who executes printing with priority, the determination unit executes processing of determining whether a third threshold is exceeded, the third threshold being equal to or less than the upper limit number and indicating an upper limit number of priority users who executes printing with priority among the users,
the relay server includes
a count unit configured to count the priority transmitter indicated by the transmitter information as the priority user when the determination unit determines that the third threshold is not exceeded, and
a total number storage unit configured to store a total number of the priority users according to a count by the count unit, and
when the transmitter of the print data is the priority user, the execution unit executes print processing on the print data acquired by the print data acquisition unit.

7. The relay server according to claim 6, wherein
the information acquisition unit acquires information indicating whether the transmitter is the priority transmitter from the first print processing system.

8. The relay server according to claim 6, wherein
when the transmitter indicated by the transmitter information is not the priority transmitter, the determination unit executes processing of determining whether a fourth threshold obtained by subtracting the third threshold from the first threshold is exceeded,
when the determination unit determines that the fourth threshold is not exceeded, the count unit counts the transmitter indicated by the transmitter information as the user,
the total number storage unit stores a total number of the users according to a count by the count unit, and
when the transmitter of the print data is the user, the execution unit executes print processing on the print data acquired by the print data acquisition unit.

9. The relay server according to claim 1, further comprising:
a notification unit configured to notify the first print processing system when the determination unit determines that the first threshold is exceeded.

10. The relay server according to claim 1, further comprising:
the second print processing system.

11. A printing system comprising:
a relay server coupled to a first print processing system; and
a second print processing system coupled to the relay server and coupled to an image forming apparatus, wherein
the relay server is a server that relays between the first print processing system and the second print processing system, and includes
a print data acquisition unit configured to acquire print data from the first print processing system,
an information acquisition unit configured to acquire transmitter information indicating a transmitter who transmits the print data to the first print processing system,
a determination unit configured to determine, based on the transmitter information, whether a first threshold indicating an upper limit number of users of the relay server is exceeded, and
an execution unit configured to execute processing of outputting, to the second print processing system, an instruction of print processing in the image forming apparatus on the print data acquired by the print data acquisition unit, when the determination unit determines that the first threshold is not exceeded, and
the second print processing system instructs the image forming apparatus to execute the print processing according to the instruction.

12. A relay method for executing relay processing of relaying between a first print processing system and a second print processing system coupled to an image forming apparatus, the relay method comprising:
acquiring print data from the first print processing system;
acquiring transmitter information indicating a transmitter who transmits the print data to the first print processing system;
determining, based on the transmitter information, whether a first threshold indicating an upper limit number of users provided with a service of the relay processing is exceeded; and
when it is determined that the first threshold is not exceeded, executing print processing in the image forming apparatus on the acquired print data via the second print processing system.

13. A non-transitory computer-readable storage medium storing a program for causing a computer to execute relay processing of relaying between a first print processing system and a second print processing system coupled to an image forming apparatus, wherein
the relay processing includes:
acquiring print data from the first print processing system;
acquiring transmitter information indicating a transmitter who transmits the print data to the first print processing system;
determining, based on the transmitter information, whether a first threshold indicating an upper limit number of users provided with a service of the relay processing is exceeded; and
when it is determined that the first threshold is not exceeded, executing print processing in the image forming apparatus on the acquired print data via the second print processing system.
